(19) United States
(12) Patent Application Publication
(10) Pub. No.: US 2013/0200801 A1
(43) Pub. Date: Aug. 8, 2013

(54) BYPASS CIRCUIT FOR SERIES CONNECTED LEDs USED FOR BACKLIGHTING

(71) Applicant: Roger Fratti, Mohnton, PA (US)

(72) Inventor: Roger Fratti, Mohnton, PA (US)

(21) Appl. No.: 13/364,408

(22) Filed: Feb. 2, 2012

(51) Int. Cl. H05B 37/02; H01R 43/00

(52) U.S. Cl. 315/122; 29/825

(57) ABSTRACT

Disclosed are various embodiments of bypass circuits that can be used with series connected LED strings for backlighting circuits in LCD displays. The bypass circuits can also be used for other implementations of series wired LED strings. The bypass circuit may comprise a latch, such as a silicon controlled rectifier that is connected to the output of a comparator circuit that compares the voltage at the cathode of an LED in the LED string to a reference voltage. In this manner, a circuit is created around each LED that is burned out.

### BACKGROUND

Series strings of LEDs are used in many different applications. One application of the use of LEDs that are connected in series is backlighting for LCD displays, such as flat screen computer displays and flat screen TV displays. LCD strings provide a reliable and inexpensive source of backlighting. Typically, LEDs may have a lifetime of 20,000 hours or more. In addition, LED strings use very little energy for the amount of light that is generated. Accordingly, LED strings provide a good source of light for backlighting LCD displays. LED series strings also can be used for various other purposes.

### SUMMARY

An embodiment of the present invention may therefore comprise a method of making a series connected string of light emitting diodes for use as backlighting for a liquid crystal display comprising: connecting a current source to the series connected string of light emitting diodes; connecting a latch in parallel with each light emitting diode in the series connected string of light emitting diodes; connecting a first input of a comparator to a reference voltage and a second input of the comparator to a cathode of a light emitting diode in the series connected string of light emitting diodes; connecting an output of the comparator to the latch.

An embodiment of the present invention may further comprise a backlighting circuit for liquid crystal displays comprising: a constant current source that supplies a substantially constant current; an LED light string having a plurality of LEDs connected in series with the constant current source; a comparator having a first input connected to a reference voltage, a second input connected to an anode of one LED of the plurality of LEDs in the LED light string, the comparator generating an output signal whenever a voltage difference exists between the first input and the second input; a latch having an input that is connected to the anode of the LED, an output connected to a cathode of the LED and latch trigger that is connected to the output of the comparator, which causes the latch to create a circuit around the LED upon detection of the output signal.

### BRIEF DESCRIPTION OF THE DRAWINGS

FIG. 1A is a schematic circuit diagram of two series LED strings that are connected to a current mirror.

FIG. 1B is a schematic circuit diagram of two circuit series connected LED strings that are connected to two separate constant current sources.

FIG. 2A is a schematic circuit and block diagram of an embodiment illustrating the use of bypass circuits associated with series connected LED strings that are connected to a current mirror.

FIG. 2B is a schematic block diagram of bypass circuits utilized in conjunction with two separate series connected LED strings.

FIG. 3A is a schematic circuit diagram illustrating bypass circuits utilized in the embodiment of FIG. 2A.

FIG. 3B is a partial circuit diagram of the embodiment of FIG. 3A.

### DETAILED DESCRIPTION OF THE EMBODIMENTS

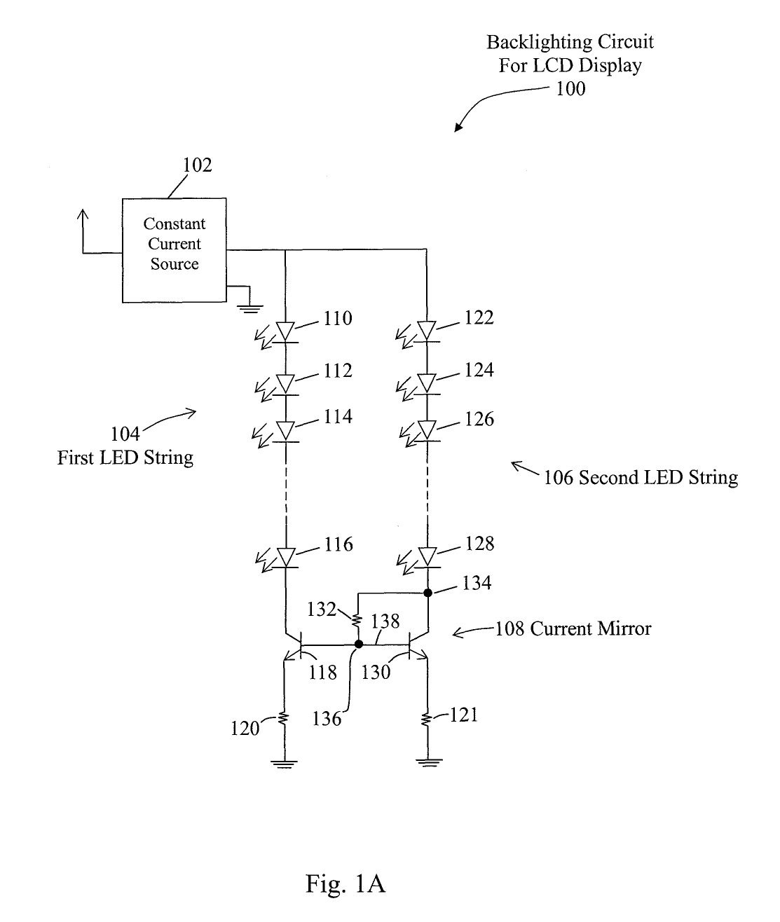

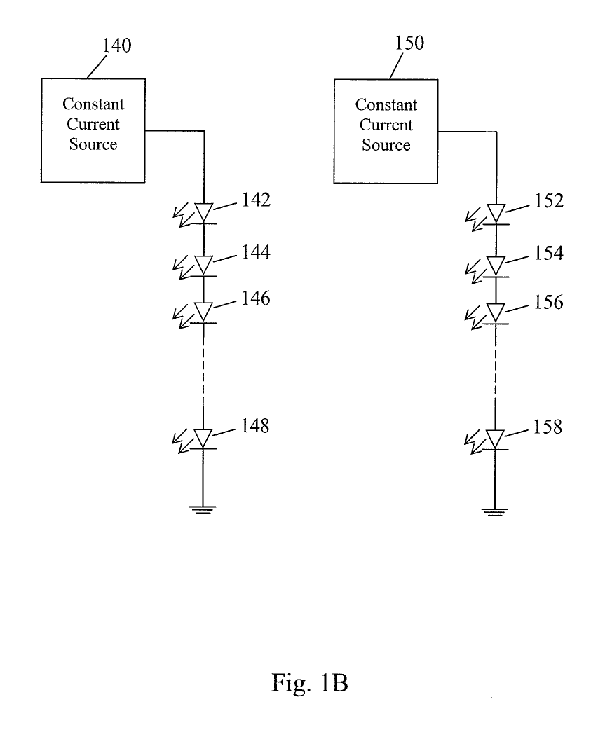

FIG. 1A is a schematic circuit diagram of a backlighting circuit 100 for an LCD display. LCD displays normally include a backlighting circuit that increases the brightness of the LCD display screen. The backlighting circuit may use fluorescent lights, LEDs or other light sources. LED strings are reliable and inexpensive to operate. As illustrated in FIG. 1A, first LED string 104 includes LEDs 110, 112, 114, 116, which are all connected in series. Second LED string 106 includes LEDs 122, 124, 126, 128, which are also connected in series. Numerous LEDs may be included in the string, as indicated by the broken lines. Constant current source 102 is connected to both the first LED string 104 and the second LED string 106. Current mirror 108 includes transistors 118, 130 that are connected together at bases 138 and in an emitter follower configuration to resistors 120, 121, respectively, which are, in turn, connected to ground. Resistor 132 is connected to second LED string 106 at node 134 between the gates of transistors 118, 130 at node 136. Variations in current in either the first LED string 104 or second LED string 106 are balanced so that each of the LED strings 104, 106 has the same amount of current passing through the strings. As such, the LEDs 110-116 have approximately the same brightness as LEDs 122, 128. In this manner, there are substantially no variations in the brightness between the two LED strings 104, 106, as a result of the use of the current mirror 108, assuming the LEDs in the strings are balanced. In this manner, the backlighting of an LCD display remains substantially constant.

FIG. 1B is another illustration of two series connected LED strings. Constant current source 140 provides current to LEDs 142, 144, 146, 148. Constant current source 150 provides current to LEDs 152, 154, 156, 158. The constant current sources 140, 150 are carefully calibrated so that LEDs 142-148 generate substantially the same brightness as LEDs 152, 158.

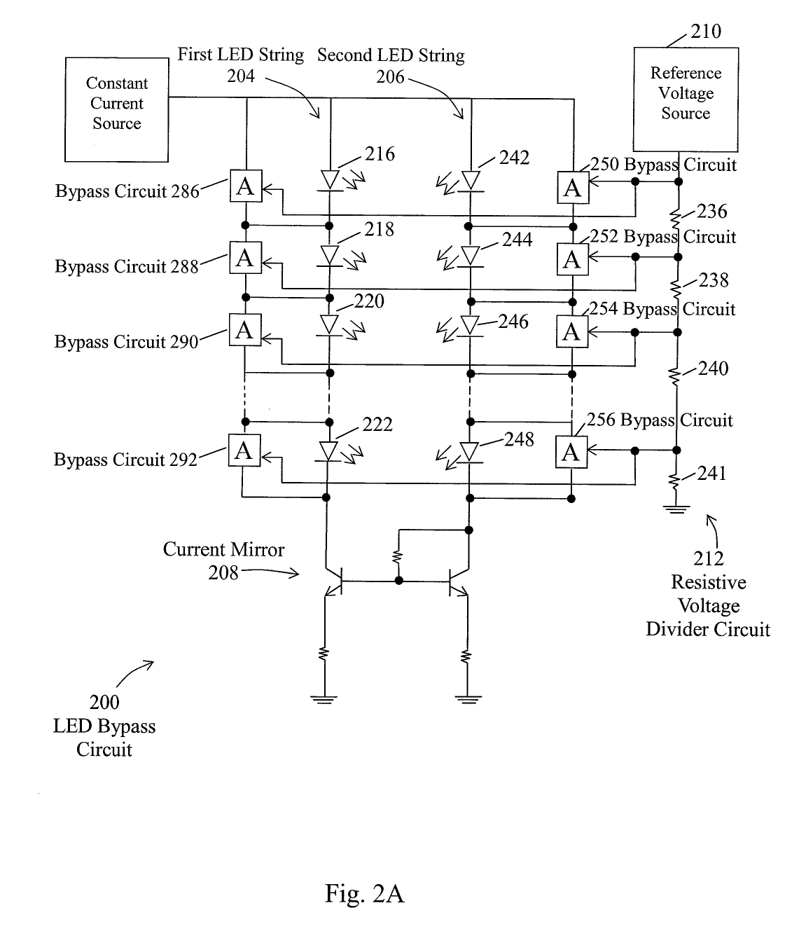

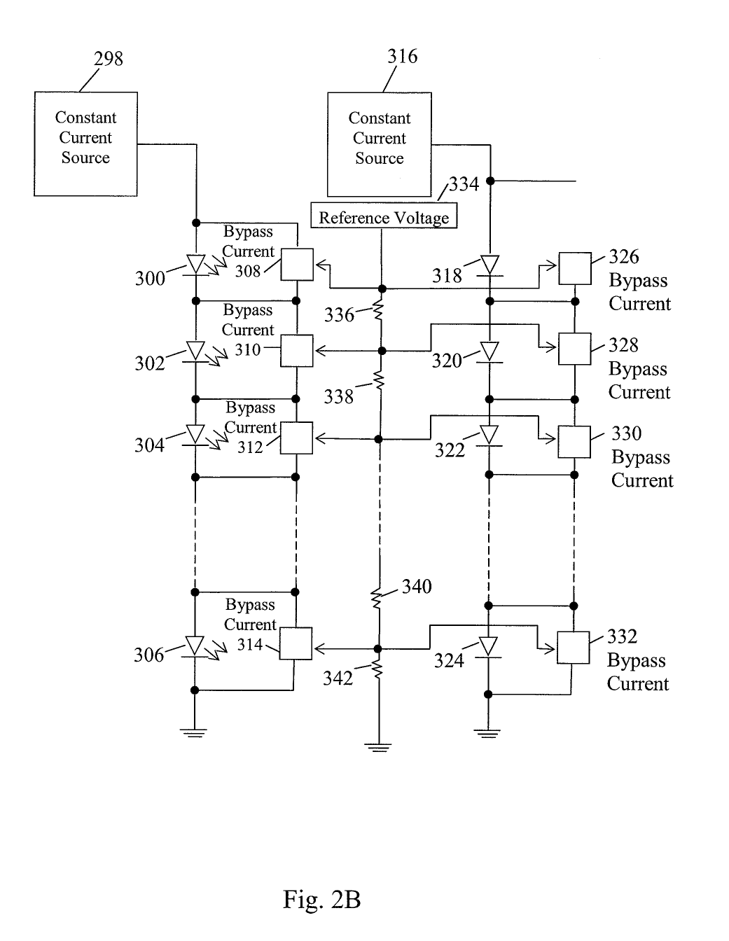

FIG. 2A is a schematic illustration of an LED bypass circuit 200. As illustrated in FIG. 2A, circuit 200 is similar to the circuit illustrated in FIG. 1A, with a series of bypass circuits 286, 288, 290, 292, 250, 252, 254, 256 that are connected around each of the LEDs 216, 218, 220, 222 in the first LED string 204, and LEDs 242, 244, 246, 248 in second LED string 206. As illustrated in FIG. 2A, the current mirror 208 is connected to both the first LED string 204 and the second LED string 206, in the same manner as illustrated in FIG. 1A, to provide substantially equal current in each of the LED series connected strings 204, 206. Since the LEDs in LED strings 204, 206 are connected in series, if a bypass circuit is not connected around each of the LEDs, and one of the LEDs burns out, the entire string on which that LED is connected will go dark. For example, in FIG. 1A, if LED 112 were to burn out, or any of the LEDs in the first string were to burn out, the entire first LED string 104 would be inoperable and dark, since a burned out LED creates an open circuit in the string. A similar circumstance can arise in the LED strings illustrated in FIG. 1B. Similarly, if LED 122 were to burn out, or any other LEDs in the second string were to burn out, the entire second LED string 106 would be inoperable and would go dark, since a burned out LED creates an open circuit in the second LED string 106.

Accordingly, bypass circuits are connected around each of the LEDs in the first LED string 204 and the second LED string 206. For example, bypass circuit 286 is connected around LED 216. Similarly, bypass circuit 288, bypass circuit 290 and bypass circuit 292 are connected around LEDs 218, 220, 222, respectively. Similarly, bypass circuits 250, 252, 254, 256 are connected around LEDs 242, 244, 246, 248. Each of the bypass circuits 286-292 and 250-256 are connected to a reference voltage source 210 through a resistive voltage divider circuit 212 having resistors 236, 238, 240, 241. The reference voltage source 210 provides a reference voltage that is resistively divided by resistive voltage divider circuit 212 to provide a series of reference voltages that are applied to each of the bypass circuits 286-292 and 250-256.

FIG. 2B illustrates the two LED strings that are similar to LED strings illustrated in FIG. 1B, which are driven by two separate constant current sources 298, 316. As illustrated in FIG. 2B, bypass circuits 308, 310, 312, 314 are connected around LEDs 300, 302, 304, 306. Similarly, bypass circuits 326, 328, 330, 332 are connected around LEDs 318, 320, 322, 324, respectively. Further, a reference voltage source 334 provides a reference voltage for each of the bypass circuits 308-314 and 326-332 by providing a voltage divider circuit that includes resistors 336, 338, 340, 342. Reference voltage 334 can supply more than two LED strings and as many strings as necessary, based upon the ability of the reference voltage source 334 to supply the requisite current to more than one string.

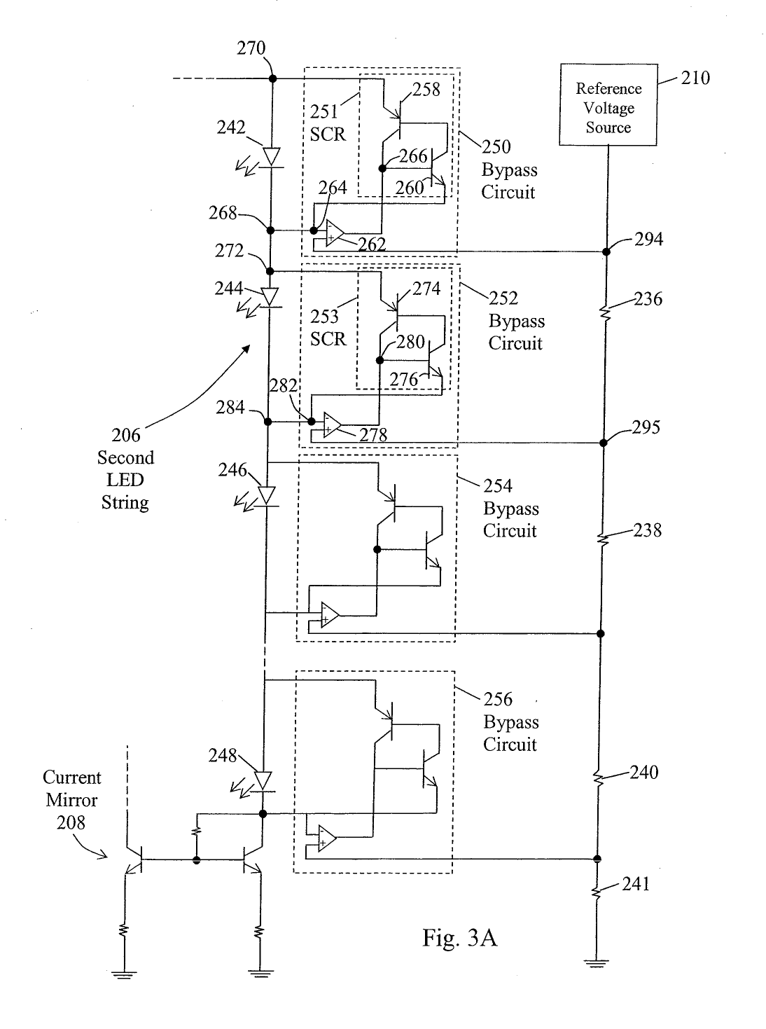

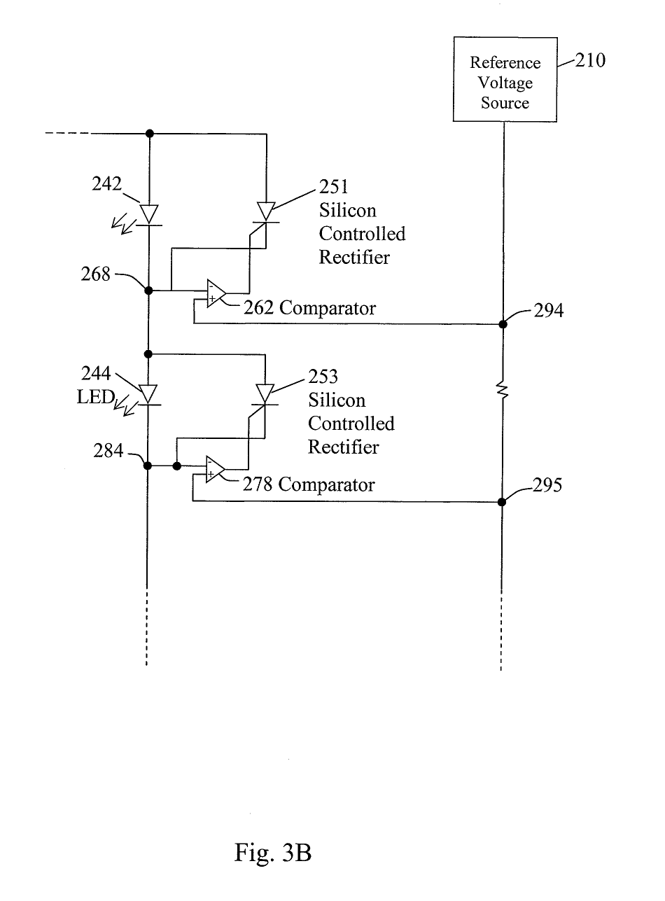

FIG. 3A is a schematic circuit diagram of a portion of the embodiment of the block diagram illustrated in FIG. 2A. As illustrated in FIG. 3A, a constant current is supplied to the second LED string 206 at node 270. Node 270 is the anode of LED 242. The cathode of LED 242 is connected to node 268. Node 270 is also connected to the silicon controlled rectifier 251, which contains the PNP transistor 258 and the NPN transistor 260 that are connected together provide a silicon controlled rectifier 251. Silicon controller rectifiers essentially consist of four layers of alternating PNPN semiconductor materials when connected in the manner shown in FIG. 3A. In the normal off state, the SCR 251 restricts current to the leakage current. When the voltage at node 266 exceeds the voltage at node 264, the SCR 251 is turned on and conducts current from node 270 to node 268. As long as current is supplied to node 270, the SCR 251 will remain in an on condition, even if the voltage at node 266 drops below a threshold value. Although the LEDs 242, 244, 246, 248 in the second LED string 206 have long operating lifetimes, occasionally one of the LEDs can burn out and causes an open circuit in the second LED string 206. If LED 242 burns out, the voltage at node 268 is low. The reference voltage supplied at node 294 is then greater than the voltage at node 268, and the comparator/operational amplifier 262 generates an output. The output of the comparator 262 is applied to node 266, which is the gate of the silicon controlled rectifier 251. Application of an output to the gate of the SCR at node 266 causes the SCR 251 to turn on. Current then flows from node 270 to node 268, as long as current is supplied to node 270. In this manner, a circuit is created around the LED 242 when the LED 242 burns out and causes an open circuit.

Similarly, if LED 244 burns out and creates an open circuit, and bypass circuit 252 creates a circuit around LED 244. The voltage at node 284 goes low. A reference voltage is supplied at node 295 to the comparator 278. When the voltage at node 282 is lower than the reference voltage at node 295, comparator 278 then generates an output which is applied to node 280. Transistors 274, 276 function as a silicon controlled rectifier 253, which latches to an on condition. Current at node 272 then flows through the SCR 253 to node 284, which creates a bypass circuit 252 around LED 244 when LED 244 burns out.

Bypass circuit 254, illustrated in FIG. 3A, functions in the same manner with respect to LED 246. Similarly, bypass circuit 256 operates in the same manner with respect to LED 248. Current mirror 208 is also illustrated in FIG. 3A and functions in the same manner as described above. A reference voltage source 210, which is connected to the resistive series string, which includes resistors 236, 238, 240, 241, supplies the series of reference voltages. In this manner, whenever an LED in the second LED string burns out, the bypass circuits 250-256 provide a circuit that is connected around each of the LEDs 242-248.

FIG. 3B is another schematic representation of a portion of the circuit illustrated in FIG. 3A. As illustrated in FIG. 3B, LED 242 is connected in parallel to a silicon controlled rectifier 251. Comparator 262 compares the voltage at node 268 with the reference voltage at node 294. When LED 242 burns out, the voltage at node 268 goes low compared to the reference voltage at node 294. Comparator 262 then triggers the silicon controlled rectifier 251, which turns on and creates a circuit around the LED 242. Similarly, LED 244 is connected in parallel with silicon controlled rectifier 253. Comparator 278 compares the voltage at node 284 to the reference voltage at node 295. When LED 244 bums out, the voltage at node 284 goes low, which causes the comparator 278 to generate an output, which is applied to the gate of silicon controlled rectifier 253. When an output is applied to the silicon controlled rectifier 253, the silicon controlled rectifier is activated and generates a circuit around LED 244. In this manner, when any of the LEDs in the series connected LED string burn out, a comparator triggers the silicon controlled rectifier to create a circuit around the LED, so that the entire string does not go dark. Although an SCR latch has been illustrated in the various embodiments, other types of latches or switches can be used without departing from the spirit of the invention.

Hence, the various embodiments disclosed herein provide a bypass circuit around LEDs that burn out and cause an open circuit. A silicon controlled rectifier latch can be used in combination with a comparator, which latches the bypass circuit. In this manner, series connected LED light strings will not go dark if one or more LEDs burn out.

The foregoing description of the invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A method of making a series connected string of light emitting diodes comprising:
connecting a current source to said series connected string of light emitting diodes;
connecting a latch in parallel with each light emitting diode in said series connected string of light emitting diodes;
connecting a first input of a comparator to a reference voltage and a second input of said comparator to a cathode of a light emitting diode in said series connected string of light emitting diodes;
connecting an output of said comparator to said latch.

2. The method of claim 1 further comprising:
placing said at least one series string of light emitting diodes in locations to backlight an LCD display.

3. The method of claim 1 further comprising:
connecting a current mirror to said series connected string of light emitting diodes and a second series connected string of light emitting diodes that balances current in said series connected string of light emitting diodes and said second series connected string of light emitting diodes to generate substantially uniform brightness from said series connected string of light emitting diodes and said second series connected string of light emitting diodes.

4. The method of claim 1 wherein said process of connecting said constant current source to said series connected string of light emitting diodes comprises:
connecting a separate constant current source to additional series connected strings of light emitting diodes.

5. The method of claim 1 wherein said series connected string of light emitting diodes is used as backlighting for a liquid crystal display.

6. The method of claim 5 wherein said liquid crystal display is used in a high definition television.

7. The method of claim 5 wherein said liquid crystal display is used in a computer laptop.

8. The method of claim 5 wherein said liquid crystal display is used in a tablet computer.

9. The method of claim 5 wherein said liquid crystal display is used in a video player.

10. The method of claim 1 wherein said process of connecting a latch comprises connecting a silicon controlled rectifier in parallel with each light emitting diodes in said series connected string of light emitting diodes.

11. An LED lighting circuit comprising:
a constant current source that supplies a substantially constant current;
an LED light string having a plurality of LEDs connected in series with said constant current source;
a comparator having a first input connected to a reference voltage, a second input connected to an anode of one LED of said plurality of LEDs in said LED light string, said comparator generating an output signal whenever a voltage difference exits between said first input and said second input;
a latch having an input that is connected to said anode of said LED, an output connected to a cathode of said LED and latch trigger that is connected to said output of said comparator, which causes said latch to create a circuit around said LED upon detection of said output signal.

12. The LED lighting circuit of claim 11 wherein said LED lighting circuit is disposed in a liquid crystal display.

13. The LED lighting circuit of claim 11 further comprising:
a current mirror connected to said LED light string and an additional LED light string that balances current flowing through said LED light string and said additional LED light string.

14. The LED lighting circuit of claim 11 further comprising:
an additional LED light string connected to another constant current source.

15. The LED lighting circuit of claim 11 wherein said latch comprises:
a silicon controlled rectifier having an SCR input anode that is connected to said anode of said LED, an SCR cathode connected to said cathode of said LED and an SCR gate that is connected to said output of said comparator, which causes said silicon controlled rectifier to latch and create a circuit around said LED upon detection of said output signal.

16. The LED lighting circuit of claim 11 wherein said LED light string comprises a source of backlighting for a liquid crystal display.

17. The LED lighting circuit of claim 11 wherein said liquid crystal display comprises a high definition television.

18. The LED lighting circuit of claim 11 wherein said liquid crystal display comprises a display in a computer laptop

19. The LED lighting circuit of claim 11 wherein said liquid crystal display comprises a display in a tablet computer.

20. The LED lighting circuit of claim 11 wherein said liquid crystal display comprises a display in a video player.
